(19) United States
(12) Patent Application Publication
(10) Pub. No.: US 2006/0272173 A1
(43) Pub. Date: Dec. 7, 2006

(54) Laundry dryer

(75) Inventor: Hwan Joo Myung, Kimhae-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/437,689

(22) Filed: May 22, 2006

(30) Foreign Application Priority Data
May 23, 2005 (KR) 10-2005-42891

(51) Int. Cl. F26B 3/00; F26B 21/06; D06F 58/00

(52) U.S. Cl. 34/469; 34/73; 34/125

(57) ABSTRACT

A laundry dryer is provided. The laundry dryer includes a drying drum to put laundry in, a base, and a condensed water storage. The base forms a passage to exhaust water vapor passing through the drying drum to the outside. The condensed water storage stores moisture contained in the water vapor.

### BACKGROUND OF THE INVENTION

1. Field of the Invention

The present invention relates to a laundry dryer, and more particularly, to a condensed water storing structure for preventing water that condenses during a drying cycle leaking from the dryer to the outside.

2. Description of the Related Art

A drum dryer is a home appliance that dries laundry by circulating hot, dry air within a drying drum to dry laundry inserted therein.

Drum dryers are divided into condenser dryers that circulate air between the drying drum and a heater to dry laundry inside the drum, and vented dryers that direct air heated by a heater into the drying drum to dry laundry, after which the air is exhausted from the drying drum to the outside.

In further detail, in a vented dryer, indoor air that enters the dryer passes through a heater and a drum, and then passes through a lint filter to shed lint. The air that passes through the lint filter then flows through an exhaust tube formed at the bottom of the dryer, to be exhausted to the outside.

However, in a vented dryer according to the related art, the exhaust tube is usually a cylindrical tube formed in a straight line from the front to the rear of the dryer. Because the exhaust tube is short, the water vapor does not have sufficient time to condense while exiting the dryer through the exhaust tube to the outside. Thus, the hot water vapor is exhausted in the same state to the outside.

Also, in a vented laundry dryer according to the related art, the water condensed from the air that flows through the inside of the exhaust is exhausted and accumulates around the dryer.

### SUMMARY OF THE INVENTION

Accordingly, the present invention is directed to a laundry dryer that substantially obviates one or more problems due to limitations and disadvantages of the related art.

An object of the present invention is to provide a laundry dryer that prevents moisture condensed from air during a drying cycle from collecting outside the dryer.

Another object of the present invention is to provide a laundry dryer that prevents hot and moist water vapor formed in a drying cycle from being expelled as is to the outside of the dryer, so that wallpaper is not damaged or mold accumulates from the water vapor.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a laundry dryer including: a drying drum for putting laundry in; a base forming a passage for exhausting water vapor passing through the drying drum to an outside; and a condensed water storage for storing moisture contained in the water vapor.

In another aspect of the present invention, there is provided a laundry dryer including: a base including a base lower unit having a condensed water pan for storing condensed water formed during a drying cycle, and a base upper unit coupled to the base lower unit; and a drying drum for holding laundry within and having hot, dry air enter within to dry the laundry; wherein water vapor passing through the drying drum enters an inside of the base and is then exhausted to an indoor area.

In a further aspect of the present invention, there is provided a laundry dryer including: a base within which at least a portion of hot, moist water vapor passing through a drying drum condenses; wherein condensed water is stored within the base, and only gas is exhausted to an indoor area.

The above-structured laundry dryer, according to the present invention, has a condensed water storing structure for preventing water that is condensed while hot and moist air leaves the drying drum and flows through the exhaust passages from leaking to the outside.

Specifically, condensed water formed during the exhausting of the hot and moist air is prevented from leaking to the outside, so that water does not accumulate on the floor around the dryer and the indoor area is kept hygienic.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is an exploded perspective view of a dryer according to the present invention;

FIG. 2 is a perspective view of a base that is installed in a dryer according to the present invention;

FIG. 3 is a perspective view of a lower unit of a base according to the present invention;

FIG. 4 is a perspective view of an upper unit of a base according to the present invention;

FIG. 5 is a bottom plan view of the upper unit in FIG. 4; and

FIG. 6 is a plan view of a base according to the present invention showing the flow of air therethrough.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

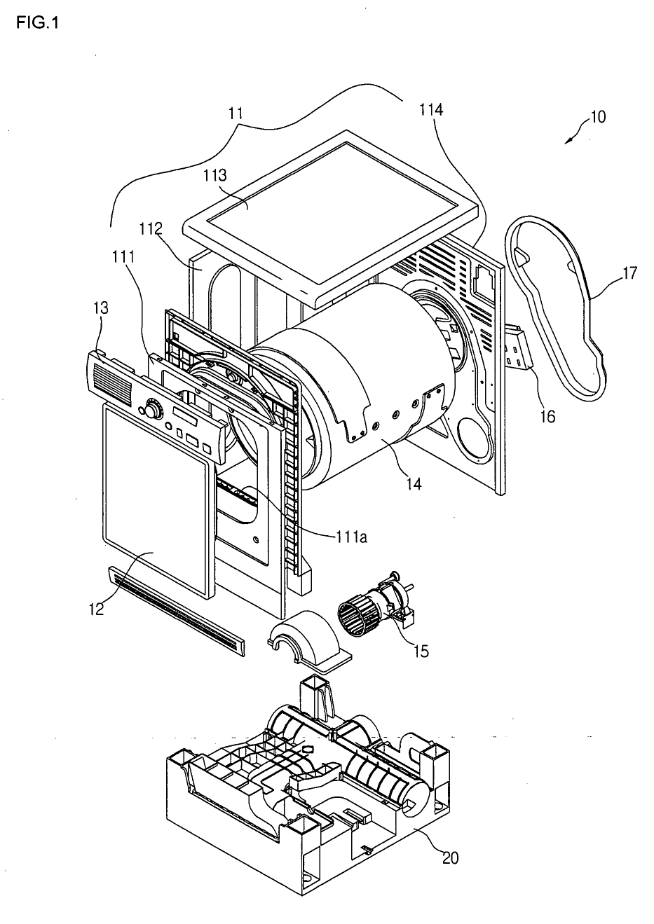

FIG. 1 is an exploded perspective view of a dryer according to the present invention.

Referring to FIG. 1, a dryer 10 according to the present invention includes a drying drum 14 for putting laundry into, a cabinet 11 installed outside the drying drum 14 for protecting the drying drum 14, a base 20 installed below the drying drum 14 and having an air exhaust duct formed within, and a motor 15 mounted on the upper portion of the base 20 for driving the drying drum 14.

In more detail, the cabinet 11 includes a front cover 111 installed at the front of the drying drum 14 for supporting the front portion of the drying drum 14, a side cover 112 installed on the side of the drying drum 14, and a back cover 114 installed at the rear of the drying drum 14 to support the same.

The dryer 10 also includes a door 12 pivotally installed at the front of the front cover 111, a control panel 13 installed above the door 12 and having buttons for inputting dryer settings and operation, a drying duct 17 installed at the rear of the back cover 114 to guide heated air into the drying drum, and a heater 16 installed inside the drying duct 17 to heat the outside air drawn in.

The operation of the above-described dryer 10 will now be explained.

First, a user opens the door 12 and inserts laundry into the drying drum 14. Then, using the setting portion on the control panel 13, the user inputs dryer settings. When the start button is pressed, the motor 15 rotates and the heater 16 installed inside the drying duct 17 is heated. A blower connected to the shaft of the motor 15 rotates according to the rotation of the motor 15, suctioning outside air into the dryer 10.

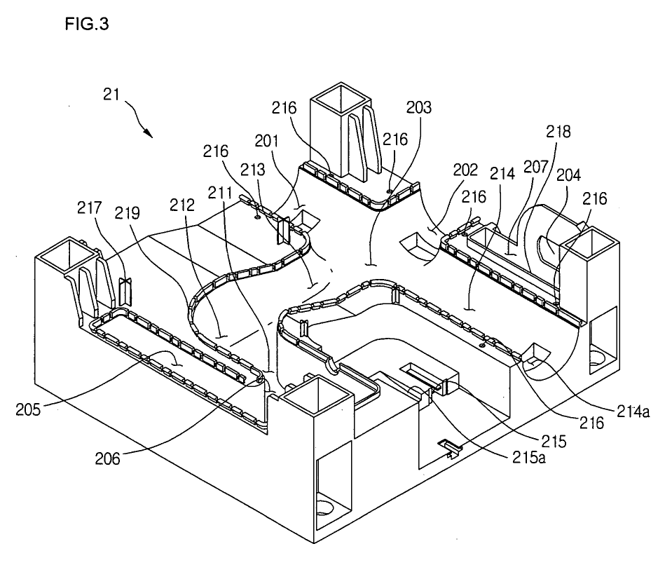

In more detail, outside air enters the drying duct 17 through an outside air intake port 204 (in FIG. 3) formed at the bottom of the back cover 114, and is heated by the heater 16 while passing through the drying duct 17. The heated air enters the drying drum 14 through a rear wall of the drying drum 14. The heated air that enters the drying drum 14 absorbs moisture imbued in laundry and becomes water vapor. The air that becomes hot and moist by absorbing the moisture in the laundry leaves the drying drum 14 through a front opening. The hot, moist water vapor that leaves the drying drum 14 passes through a lint filter 111a formed on the front cover 111, shedding impurities such as lint in the process.

The air that passes through the lint filter 111a flows along the exhaust passage installed on the base 20, and is ultimately exhausted out from the dryer 10 (or to an indoor area). Here, the base 20 forms a passage within for air to be exhausted, and exhaust ports are formed on the sides and rear of the base 20. One of the exhaust ports may be open while the remaining ports may be sealed. The air passage formed within the base 20 will be described in further detail below with reference to the diagrams.

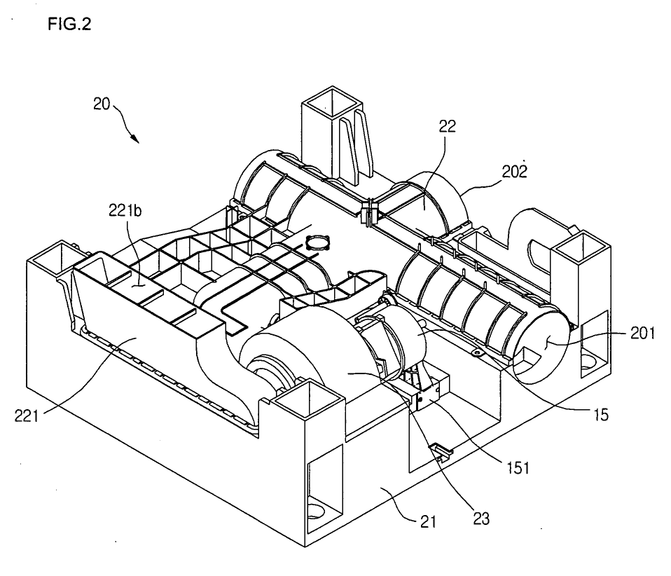

FIG. 2 is a perspective view of a base that is installed in a dryer according to the present invention.

Referring to FIG. 2, the base 20 of the dryer according to the present invention includes a base lower unit 21 (on which the motor 15 is mounted) and a base upper unit 22 mounted on top of the base lower unit 21. In detail, the passage for exhausting air is formed within the upper part of the base lower unit 21. The base upper unit 22 covers the air passage, so that the exhausting air is not dispersed but directed to flow in a predetermined direction.

In further detail, the base lower unit 21 and the base upper unit 22 are respectively plastic injection molded and coupled together in one piece by means of fasteners. A drum connecting duct 221 of a predetermined height is formed at the front upper portion of the base 20, and a drum connecting hole 221b is formed within the drum connecting duct 221. A side exhaust port 201 is formed at the side and a rear exhaust port 202 is formed at the rear of the base 20. The motor 15 is mounted to one side on top of the base 20, and a blower (see FIG. 1) is installed to the rotating motor shaft to suction air from inside the drum. The blower is protected by a blower cover 23.

In the above-described structure, the hot, moist discharged from the front of the drying drum 14 enters the drum connecting hole 221b and is exhausted back to the outside through the side exhaust port 201 and/or the rear exhaust port 202. Below, a detailed description of the air passages formed within the base 20 will be given, with reference to the diagrams.

FIG. 3 is a perspective view of a lower unit of a base according to the present invention.

Referring to FIG. 3, the base 20 according to the present invention, as described above, includes a base lower unit 21 and a base upper unit 22 mounted on top of the base lower unit 21.

In detail, the bottom portion of an air passage, through which air is exhausted from the drying drum 14, is formed in the base lower unit 21, and the air passage is completed by the base upper unit 22 formed to cover the base lower unit 21.

In more detail, a drum air descending passage 205, for the air passing from the drying drum 14 to descend, is formed at the front of the base lower unit 21. A blower entrance 206 is formed on one side of the drum air descending passage 205 for the descending air to be suctioned toward the blower. A blower compartment 211 is formed for mounting the blower at the blower entrance 206. An expanded passage portion 212 that bends at a predetermined angle and expands in diameter is connected to an end of the blower compartment 211. A main passage 213 that extends to the rear end of the base lower unit 21 is connected at the end of the expanded passage portion 212. Here, the main passage 213 changes in direction from the expanded passage 212 portion and extends to the rear of the base lower unit 21.

A sub passage 214 is formed to intersect with the main passage 213, forming the side exhaust ports 201 at either side of the base lower unit 21. A condensation pan 214a is respectively formed a predetermined depth into the floors at the rear exhaust port 202 and side exhaust ports 201, to collect condensing moisture from the exhausting air.

Specifically, the condensation pans 214a have a predetermined size and depth and are formed in the floor surfaces of the main and sub passages 213 and 214, close to end portions thereof. The condensation pans 214a collect water condensed during the flow of air through the passages, minimizing leakage of condensed water outside of the dryer. In this way, the water condensed within the main and sub passages 213 and 214 is stored in the condensation pans 214a, preventing condensed water from leaking out of the dryer along with exhausted air and collecting on the floor around the dryer.

Here, the locations, dimensions, and number of condensation pans 214a are not limited to those in this embodiment, and the condensation pans 214a may be formed anywhere in the floors of the main and/or sub passages 213 and 214.

The condensation pans 214a, instead of being formed at the ends of the main and sub passages 213 and 214, may be formed along the lengths of their floors.

For example, the condensation pan 214a may be formed with a predetermined width and depth from one end to extend to the other end of the main passage 213. In other words, it may be formed in a length beginning at the blower compartment 211 and extending to a point a predetermined distance from the rear exhaust port 202. Here, the reason for locating the end of the condensation pan 214a a predetermined distance from the end of the rear exhaust port 202 has already been discussed above.

Likewise, the condensation pan 214a may be formed in the same fashion in the floor of the sub passage 214.

A passage intersection 203 of the main passage 213 and the sub passage 214 is biased toward the rear of the base lower unit 21 from its center. That is, the sub passage 214 is closer to the rear of the base lower unit 21 than its front.

A plurality of base upper unit guiding protrusions 217 are formed to protrude from the top surface of the base lower unit 21, in order to guide the mounting position of the base upper unit 22 over the base lower unit 21. A fastening hook 219 is formed to protrude a predetermined height from along the perimeters of the main and sub passages 213 and 214, in order to tightly couple the base upper unit 22 to the base lower unit 21. Also, a plurality of fastening holes 216 are formed in the upper surface of the base lower unit 21, so that a fastening members (for passing through the base upper unit 22) can insert through the fastening holes 216. Specifically, the fastening holes 216 are formed symmetrically at the edges on either sides of the sub and main passages 214 and 213.

An outside air intake port 204 is formed at the rear of the base lower unit 21, to allow outside air to pass through the drying duct 17 into the drying drum. A lint entry preventing slot 207 recessed at a predetermined depth is formed at the front of the outside air intake port 204 for trapping lint and other impurities contained in outside air suctioned through the outside air intake port 204, and preventing the impurities from entering the drying duct 17.

In more detail, a small amount of the hot, moist air that may leak through small gaps between the coupling portions of the base upper unit 22 and the base lower unit 21 may mix with the outside air suctioned through the outside air intake port 204. Here, the air that may leak through the gaps is moist vapor flowing along the main and sub passages 213 and 214.

Lint particles that have not been filtered by the lint filter 111a may be contained in the air from the drying drum 14 that passes through the passages and leaks through the gaps therein.

Despite this, the impurities contained within the outside air suctioned through the outside air intake port 204 will be caught in the lint entry preventing slot 207, thereby reducing the amount of impurities that enters the drying duct 17.

A lint entry preventing ledge 218 is formed to protrude a predetermined height from around the upper perimeter of the lint entry preventing slot 207. That is, by forming the lint entry preventing ledge 218, impurities that leak through gaps are blocked in a first stage. The air filtered in a first stage by the lint entry preventing ledge 218 is filtered once more in the lint entry preventing slot 207.

A motor mount 215a for mounting the motor 15 is formed in the space between the blower compartment 211 and the sub passage 214. Also, an insert slot 215 of a predetermined length is formed to the rear of the motor mount 215a, to insert the bottom portion of a motor supporter (not shown) for supporting the motor 15 therein.

In the above structure, the hot, moist air that descends through the drum air descending passage 205 flows through the blower entrance 206 into the blower compartment 211. The air that enters the blower compartment 211 flows through the expanded passage portion 212 to the main passage 213. The air that flows to the main passage 213 branches at the passage intersection 203 and flows through at least one of the side exhaust ports 201 and/or the rear exhaust port 202 to the outside.

Here, one side of the two side exhaust ports 201 and the rear exhaust port 202 may be closed with caps and the remainder sealed, or all of the exhaust ports may be opened, according to a user's specifications. Accordingly, air that is discharged toward closed or sealed exhaust ports are redirected to exhaust ports that are opened, condensing along the way. The condensed water accumulates in the condensation pans 214a. Also, even when all the exhaust ports 201 and 202 are open, air that flows toward the exhaust ports condenses, whereupon the condensed water accumulates in the condensation pans 214a.

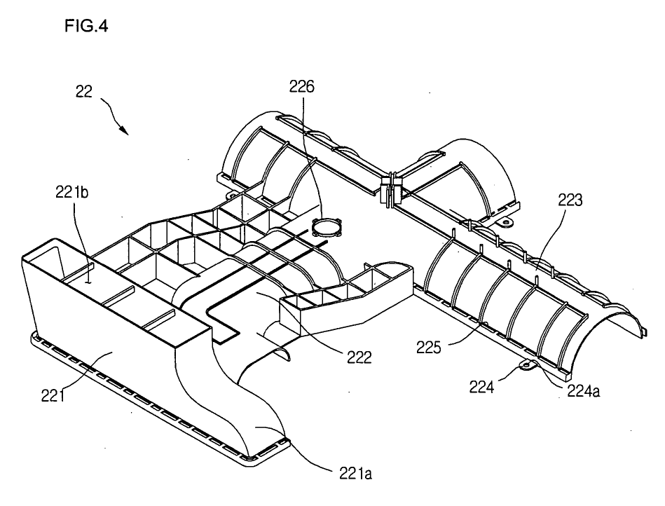

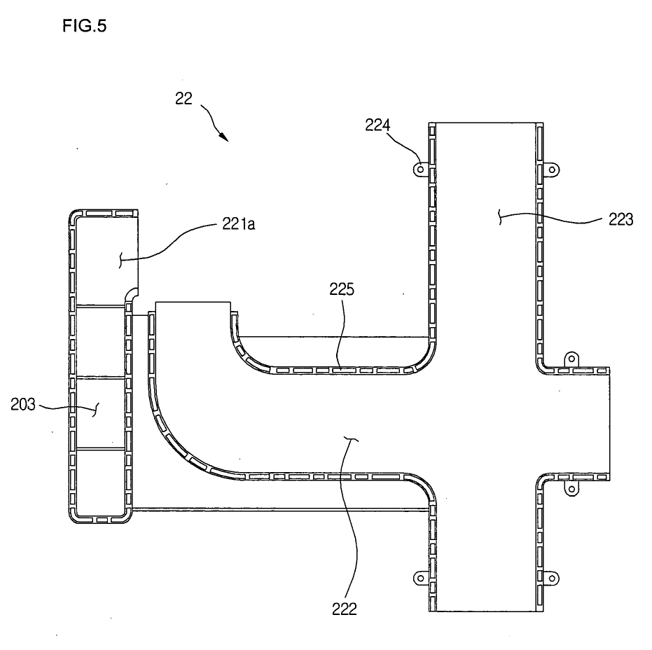

FIG. 4 is a perspective view of an upper unit of a base according to the present invention, and FIG. 5 is a bottom plan view of the upper unit in FIG. 4.

Referring to FIGS. 4 and 5, the base upper unit 22 according to the present invention, as described above, is mounted on top of the base lower unit 21.

Specifically, the base upper unit 22 is formed in a shape corresponding to that of the base lower unit 21 in terms of the passages, in order to seal the upper portion of the passages. A drum connecting passage 221b is formed at the front of the base upper unit 22, to provide an entrance for hot, moist air exiting the drying drum 14 toward the passages.

In more detail, the drum connecting passage 221b extends a predetermined distance upward from the top of the base upper unit 22 to form the interior of a drum connecting duct 221, already described. A blower connecting portion 221a is formed to extend from the side of the drum connecting duct 221, so that descending air passes through the drum connecting passage 221b and flows into the blower entrance 206 formed in the base lower unit 21.

A main passage cover 222 and a sub passage cover 223 are formed to intersect with each other on the base upper unit 22, to cover the expanded passage portion 212, the main passage 213, and the sub passage 214 formed in the base lower unit 21. A humidity sensor mount 226 is formed in a portion of the main passage cover 222 for installing a humidity sensor therein, in order to detect the level of humidity of air flowing through the main passage 213. Here, the humidity sensor mount 226 may be located in the sub passage cover 223 instead of the main passage cover 222, or may be located at the intersecting point of the main and sub passage covers 222 and 223.

Also, hook insert holes 225 are arranged at a predetermined interval apart from one another on the lower perimeters of the main passage cover 222 and the sub passage cover 223. Accordingly, the fastening hooks 219 formed at a predetermined interval apart on the base lower unit 21 insert into the hook insert holes 225.

Fastening tabs 224 are formed on the perimeters at both side ends of the sub passage cover 223 and on the end portion perimeter of the main passage cover 222. Also, a fastening hole 224a (for inserting a fastening member through) is formed in the fastening tab 224. The fastening member inserted through the fastening hole 224a fastens the base upper unit 22 to the base lower unit 21 more tightly.

In detail, the fastening member inserted in the fastening hole 224a inserts into the fastening hole 216 formed in the base lower unit 21. The fastening member is tightened, so that no gaps are formed between the base upper and lower units 22 and 21. In this way, the size of gaps formed between the base upper and lower units 22 and 21 may be minimized, preventing leakage of air flowing within the passages and the possibility of it re-entering through the outside air intake port 204.

In the above structure, the hot, moist air that exits the drying drum 14 passes through the drum connecting hole 221b and descends. The air that descends through the drum connecting hole 221b flows along the blower connecting portion 221a to enter the blower entrance 206. The air that enters the blower entrance 206 moves through the expanded passage portion 212, the main passage 213, and the sub passages 214. The air that flows through the main and sub passages 213 and 214 condenses and is exhausted to the outside through the rear exhaust port 202 and/or the side exhaust port(s) 201.

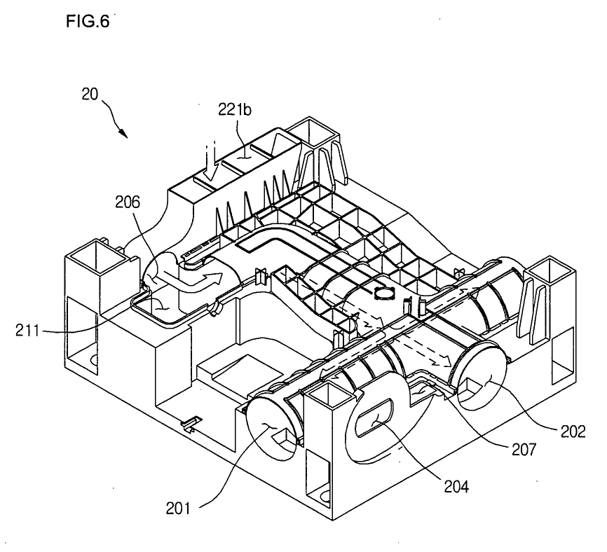

FIG. 6 is a plan view of a base according to the present invention showing the flow of air therethrough.

Referring to FIG. 6, as described above, the air that passes through the drying drum 14 passes through the lint filter 111a installed in the front cover 111 to shed impurities in a first stage, and then descends through the drum connecting hole 221b. Then, the air that descends through the drum connecting hole 221b moves to the blower entrance 206 formed at the end of the blower connecting portion 221a.

The air that moves to the blower entrance 206 is redirected by the blower installed in the blower compartment 211. The air that is redirected by the blower flows to the expanded passage portion 212. The flow direction of the air is redirected again at the expanded passage portion 212 to the main passage 213, and the air flows to the rear of the base 20. A portion of the air flowing through the main passage 213 branches off at the passage intersection 203 (where the main and sub passages 213 and 214 intersect) to the sub passages 214. The air flowing through the main and sub passages 213 and 214 flows through the rear exhaust port 202 and/or side exhaust port(s) 201 to be exhausted back to the outside. Here, the water vapor that exits the drying drum 14 cools and condenses during the time it takes to flow from the drum connecting hole 221b to the exhaust ports 201 and 202. The condensed moisture accumulates in the condensation pans 214a recessed in the floors of the main and sub passages 213 and 214.

The outside air that flows into the rear of drying drum 14, that is, outside air with the same temperature and humidity of inside air, flows through the outside air intake port 204 formed at the rear of the base 20 along the drying duct 17 into the drying drum 14. Here, the air that is suctioned through the outside air intake port 204 is indoor air within the cabinet 11 of the dryer 10. Impurities such as lint contained in indoor air suctioned through the outside air intake port 204 are trapped in a first stage by the lint entry preventing ledge 218 and lint entry preventing slot 207, as described above.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A laundry dryer comprising:
a drying drum for putting laundry in;
a base forming a passage for exhausting water vapor passing through the drying drum to an outside; and
a condensed water storage for storing moisture contained in the water vapor.

2. The laundry dryer according to claim 1, wherein the condensed water storage is a slot recessed a predetermined depth in a floor of the passage.

3. The laundry dryer according to claim 1, wherein the base includes a base lower unit forming the passage at a predetermined depth, and a base upper unit covering an open upper portion of the passage, wherein the condensed water storage is formed in the base lower unit.

4. The laundry dryer according to claim 1, wherein the condensed water storage is formed a predetermined distance inward from an end of the passage.

5. The laundry dryer according to claim 1, wherein the passage includes a main passage formed from a front to a rear of the base, and a sub passage formed to intersect the main passage.

6. The laundry dryer according to claim 5, wherein the sub passage is formed at a location closer to the rear of the base than the front of the base.

7. A laundry dryer comprising:
a base including a base lower unit having a condensed water pan for storing condensed water formed during a drying cycle, and a base upper unit coupled to the base lower unit; and
a drying drum for holding laundry within and having hot, dry air enter within to dry the laundry; wherein
water vapor passing through the drying drum enters an inside of the base and is then exhausted to an indoor area.

8. The laundry dryer according to claim 7, wherein the base lower unit forms a passage for air flowing through the drying drum, and the condensed water pan is formed in a floor of the passage.

9. The laundry dryer according to claim 8, wherein the condensed water pan is formed in a length shorter than a length of the passage.

10. The laundry dryer according to claim 8, wherein the passage is formed in at least two or more passages that intersect each other, for allowing the water vapor passing through the drying drum to sufficiently condense within the base.

11. The laundry dryer according to claim 7, wherein the condensed water pan has an end thereof spaced a predetermined distance inward from an outer edge of the base lower unit.

12. The laundry dryer according to claim 7, wherein the base forms a passage within for water vapor passing through the drying drum to flow and be exhausted to an indoor area, and at least one of the condensed water pan is formed in the passage.

13. The laundry dryer according to claim 7, wherein the base forms an exhaust port for exhausting water vapor to an indoor area on at least one of side and rear surfaces of the base, and the condensed water pan is formed at each exhaust port.

14. The laundry dryer according to claim 7, wherein the base forms a passage within that redirects a flow of water vapor at least once, and the condensed water pan is formed close to an end of the passage.

15. A laundry dryer comprising:
a base within which at least a portion of hot, moist water vapor passing through a drying drum condenses; wherein condensed water is stored within the base, and only gas is exhausted to an indoor area.

16. The laundry dryer according to claim 15, wherein the base forms at least one slot within for storing the condensed water.

17. The laundry dryer according to claim 15, wherein the base forms a water vapor passage within.

18. The laundry dryer according to claim 17, wherein the base includes:
a base lower unit forming the water vapor passage in a predetermined depth and length on an upper surface thereof; and
a base upper unit mounted on the base lower unit, for covering the water vapor passage.

19. The laundry dryer according to claim 17, wherein the water vapor passage is formed in at least two or more mutually intersecting passages.

20. The laundry dryer according to claim 15, wherein the base includes at least one water vapor exhaust port formed on a side thereof.

21. The laundry dryer according to claim 20, wherein the water vapor exhaust port is selectively closed with a cap.
